(19) United States
(12) Patent Application Publication
(10) Pub. No.: US 2006/0046015 A1
(43) Pub. Date: Mar. 2, 2006

(54) Optical recording medium and cover sheet for optical recording media

(75) Inventors: Hiroaki Takano, Kanagawa (JP); Takeshi Kakuta, Kanagawa (JP)

Correspondence Address: TAIYO CORPORATION, 401 HOLLAND LANE, #407, ALEXANDRIA, VA, 22314, US

(73) Assignee: FUJI PHOTO FILM CO., LTD.

(21) Appl. No.: 11/210,781

(22) Filed: Aug. 25, 2005

(30) Foreign Application Priority Data
Aug. 30, 2004 (JP) 2004-250847

(51) Int. Cl. B32B 3/02

(52) U.S. Cl. 428/64.4

(57) ABSTRACT

Provided are a cover sheet for optical recording media comprising a transparent disk-shaped sheet having a central hole and a hardcoat layer formed thereon wherein the hardcoat layer has a linear crack groove in the circumferential direction in the area close to the outer circumferential edge thereof; and an optical recording medium comprising a disk-shaped substrate having a central hole and at least a recording layer, a transparent sheet, and a hardcoat layer formed in that order thereon wherein the hardcoat layer has a linear crack groove in the circumferential direction in the area close to the outer circumferential edge thereof.

### CROSS-REFERENCE TO RELATED APPLICATION

This application claims priority under 35 USC 119 from Japanese Patent Application No. 2004-250847, the disclosure of which is incorporated by reference herein.

### BACKGROUND OF THE INVENTION

1. Field of the Invention

The present invention relates to an optical recording medium and a cover sheet for use in the optical recording medium.

2. Description of the Related Art

Further increases in the recording density of optical recording media (such as DVD-R) are currently demanded for recording text, visual or audio information in larger amounts. Research and development aimed at further improvement in the recording density of optical recording media is currently underway, in particular, to cope with the recording of digital high-vision TV programs.

In these circumstances, since the development of blue purple laser, optical disk systems employing the blue purple laser and a high-NA pickup have been under development (see, for example, Japanese Patent Application Laid-Open (JP-A) Nos. 2000-43423, 2000-108513, 2000-113504, 2000-149320, 2000-158818, and 2000-228028). Recently, Sony Corporation announced a DVR-Blue system, a phase-change recording medium employing a blue purple laser (see, for example, “ISOM2000”, pp. 210-211). Characteristically, the phase-change recording media in the DVR-Blue system have a transparent layer having a thickness of 0.1 mm, often called a cover layer (transparent sheet), on the incident laser beam side of the media.

Property requirements for the cover layer include the absence of defects such as scratches, dust, or the like (black defects), of 50 μm or more in the initial phase and no increase in the number of the defects during use. Accordingly, a hardcoat layer is usually formed on the cover layer for prevention of scratches and stains.

The hardcoat layer may be formed, for example, by coating a UV-curable resin on a transparent sheet by spin coating and thus forming a uniform hardcoat layer, but the method of spin-coating the resin layer by layer is productive. Alternatively, the hardcoat layer may be formed by the method of using a cover sheet having a hardcoat layer formed on a transparent sheet in advance, slitting the sheet to a particular width and punching the resulting sheet, and adhering the cover sheet to a substrate on a side having a recording layer.

### SUMMARY OF THE INVENTION

The latter method is more convenient and superior in productivity, but the outer circumferential edge of the cover sheet was found to separate more easily from the substrate after high temperature and high humidity preservation. It is assumed that because of the deformation of the area near the outer circumferential edge of the cover sheet and also of the hardcoat layer caused during punching, the stretching or shrinking stress due to the wet heat swelling change in the high temperature and high humidity preservation is concentrated in the area near the outer circumferential edge, consequently leading to easier exfoliation.

The present invention, which was devised in consideration of the above circumstances, provides a cover sheet for optical recording media that is resistant to separation in the edge area when used as a cover sheet for optical recording media. The invention also provides an optical recording medium that is resistant to the separation of the edge area of a cover sheet.

A first aspect of the invention provides a cover sheet for optical recording media comprising a transparent disk-shaped sheet having a central hole and a hardcoat layer formed thereon, wherein the hardcoat layer has a linear crack groove in the circumferential direction in the area close to the outer circumferential edge thereof.

A second aspect of the invention provides an optical recording medium comprising a disk-shaped substrate having a central hole and at least a recording layer, a transparent sheet, and a hardcoat layer formed in that order thereon, wherein the hardcoat layer has a linear crack groove in the circumferential direction in the area close to the outer circumferential edge thereof.

### BRIEF DESCRIPTION OF THE DRAWINGS

FIG. 1 is a schematic perspective view illustrating an example of the cover sheet for optical recording media according to the invention.

FIG. 2 is a partial sectional view illustrating the outer circumferential end portion of the cover sheet for optical recording media shown in FIG. 1 that is cut off in a radial direction.

FIG. 3 is a view illustrating an embodiment of the cover sheet for optical recording media according to the invention in which a release sheet is adhered on the cover sheet.

FIG. 4 is a partial sectional view illustrating the outer circumferential end portion of the cover sheet for optical recording media shown in FIG. 3 that is cut off in a radial direction.

FIG. 5 is a schematic sectional view illustrating the way of cutting a laminated film having a hardcoat layer on one face and a pressure sensitive adhesive layer and a release sheet on the other face of a transparent sheet.

### DETAILED DESCRIPTION OF THE INVENTION

The cover sheet for optical recording media according to the present invention includes a transparent disk-shaped sheet having a central hole and a hardcoat layer formed thereon, wherein the hardcoat layer has a linear crack groove in the circumferential direction in the area close to the outer circumferential edge thereof.

In addition, the optical recording medium according to the invention includes a disk-shaped substrate having a central hole and at least a recording layer, a transparent sheet, and a hardcoat layer formed in that order thereon, wherein the hardcoat layer has a linear crack groove in the circumferential direction in the area close to the outer circumferential edge thereof.

Hereinafter, the cover sheet for optical recording media according to the invention will be described.

<Cover Sheet for Optical Recording Media>

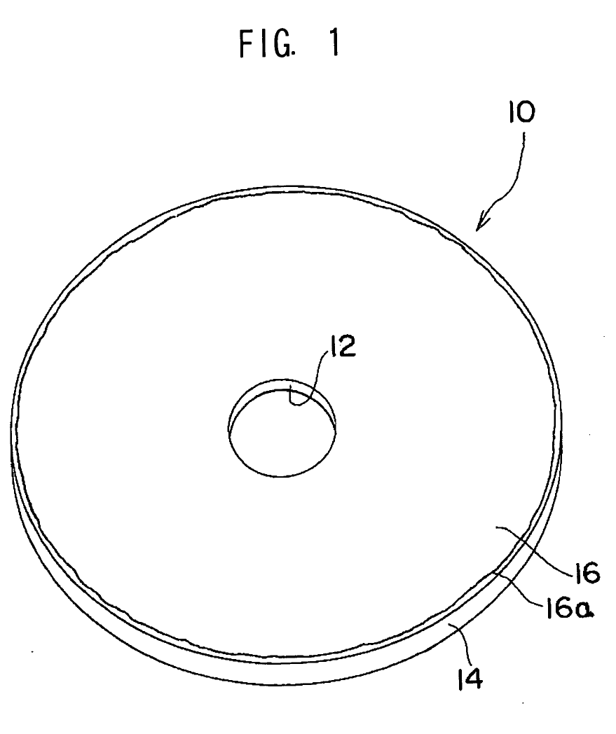

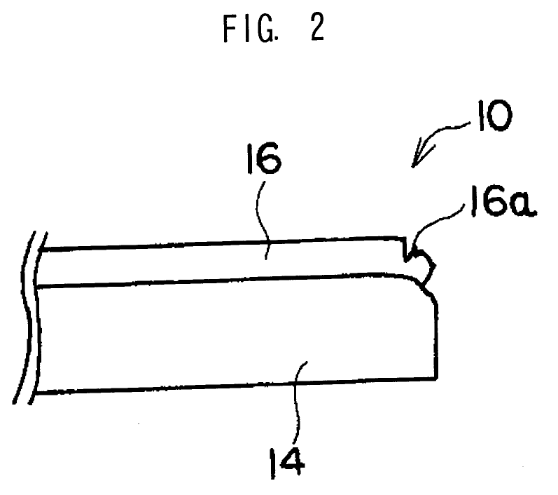

FIG. 1 is a schematic view (perspective view) illustrating an example of the cover sheet for optical recording media according to the invention, and FIG. 2 is a partial sectional view illustrating the cross section of the outer circumferential end portion of a cover sheet for optical recording media 10 cut in a radial direction. FIGS. 1 and 2 are drawn in an exaggerated form, and the dimension ratios shown therein do not reflect the actual dimension ratio. The edge at the right-hand side of FIG. 2 corresponds to the peripheral edge of the cover sheet for optical recording media. The cover sheet for optical recording media 10 shown in FIGS. 1 or 2 includes a disk-shaped transparent sheet 14 having a central hole (not shown) and a hardcoat layer 16 having a central hole 12 identical in size with the central hole described above and identical in size and shape with transparent sheet 14 formed thereon.

The hardcoat layer 16 has a linear crack groove 16a in the circumferential direction in the area close to the outer circumferential edge. The cover sheet for optical recording media 10 can relax the stretching or shrinking stress generated when stored in hot and humid conditions because of the presence of the linear crack groove 16a in the hardcoat layer 16 and can prevent separation thereof when adhered onto an optical recording medium. When used as a cover sheet for optical recording media, the cover sheet for optical recording media according to the invention can prevent separation of the edge area of the cover sheet.

The linear crack groove is preferably present around the entire circumference in the area of the hardcoat layer close to the outer circumferential edge, but may be present partially and intermittently.

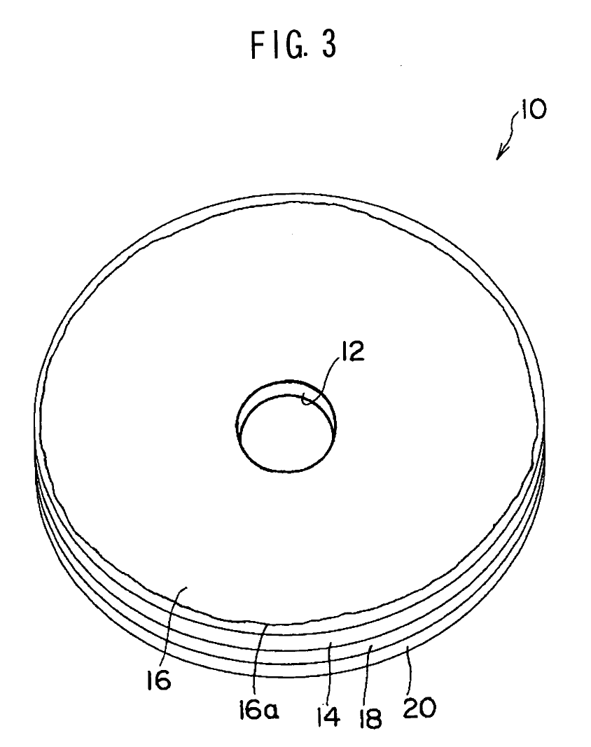

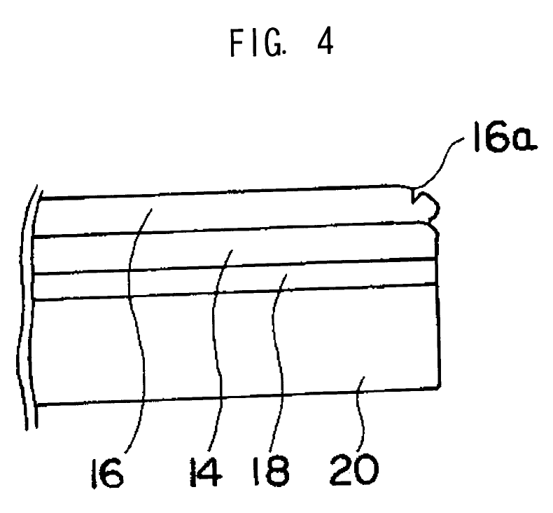

For convenience in storage and in production of the optical recording medium, the cover sheet for optical recording media according to the invention is preferably a laminated film having a release sheet 20 adhered via a pressure sensitive adhesive layer 18 onto the face of transparent sheet 14 opposite to the hardcoat layer 16, as shown in FIGS. 3 and 4. FIG. 3 is a perspective view illustrating such a laminated film, and FIG. 4 is a sectional view of part of the laminated film shown in FIG. 3 cut in a radial direction. FIGS. 3 and 4 are drawn in an exaggerated form, and the dimension ratios shown therein do not reflect the actual dimensions. The edge at the right-hand side of FIG. 4 corresponds to the outer circumferential edge of the laminated film shown in FIG. 3. In such a configuration, it is possible to adhere the cover sheet for optical recording media onto an optical recording medium by separating the release sheet 20 from the laminated film and adhering the cover sheet via the pressure sensitive adhesive layer 18 onto a particular layer of an optical recording medium.

The cover sheet for optical recording media according to the invention can be prepared, for example, by the following method.

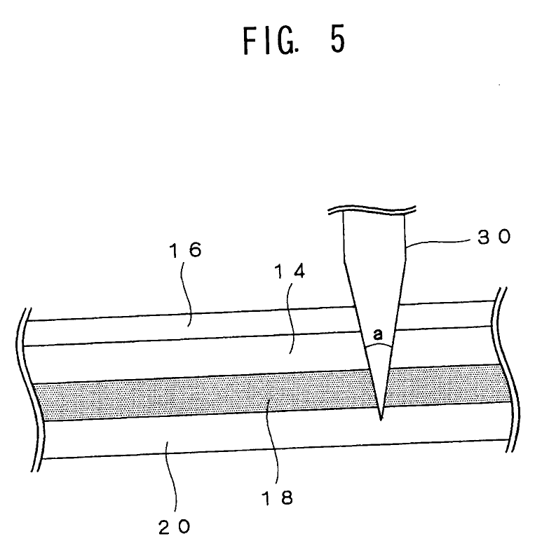

First, a transparent sheet (e.g., one wound in roll shape) larger in size than the cover sheet for optical recording media to be prepared is made available, and a laminated film consisting of the transparent sheet and a hardcoat layer and, as needed, a pressure sensitive adhesive layer and a release sheet, is formed. The laminated film is then cut (punched) into a cover sheet for optical recording media having a particular size and shape (disk), and the presence or absence of the linear crack groove in the area close to the outer circumferential edge can be decided by appropriately selecting the blade shape (blade edge angle) of the cutter used at the time. FIG. 5 is a schematic view illustrating the operation of cutting a laminated film having a hardcoat layer 16 on one face of the transparent sheet 14 and a pressure sensitive adhesive layer 18 and a release sheet 20 on the other face thereof with a cutter 30. The cutter 30 advances in a direction orthogonal to the face of the paper shown in FIG. 3, and the tip of the cutter 30 reaching the pressure sensitive adhesive layer 18 cuts the laminated film into a particular circular shape. The linear crack groove in the area close to the outer circumferential edge of hardcoat layer can be formed by adjusting the blade edge angle a of cutter 30 by preferably 20 to 60°, and more preferably 30 to 50°. Namely, it is possible to form a linear crack groove near the cut surface of the hardcoat layer 16, i.e., the area close to the outer circumferential edge of the hardcoat layer 16, by using a cutter having a blade edge angle a of 20 to 60°.

Factors involved in favorable generation of the linear crack groove include the cutoff speed and the shearing force applied in the circumferential direction (cutting while rotating the blade), as well as the blade edge angle of the cutter. Because a harder hardcoat layer often results in easier cracking, a hardcoat layer having a surface elastic modulus of 4 GPa or more is preferable. A hardcoat layer of 10 GPa in elastic modulus is brittler and thus undesirable.

Hereinafter, the materials constituting the cover sheet for optical recording media according to the invention will be described.

(Transparent Sheet)

The transparent sheet is formed for protection of the interior of the optical recording medium from contamination, scratch, shock, and others, for prevention of penetration of water, or the like. The material is not particularly limited if it is transparent, and favorable examples thereof include polycarbonate, cellulose triacetate, and the like. The transparent sheet may have a pressure sensitive adhesive adhered on at least one face.

The “transparent” material means a material so transparent that it transmits recording or reproducing light at a transmittance of 90% or more.

The thickness of the transparent sheet is preferably in the range of 0.03 to 0.15 mm and more preferably 0.05 to 0.12 mm. Advantageously in the range above, it becomes easier to handle and to suppress the coma aberration.

(Hardcoat Layer)

The radiation-curable resin for use in the hardcoat layer may be any resin that can be hardened by radiation, and specifically, the radiation-curable resin is preferably a resin having two or more radiation-sensitive double bonds in the molecule.

Examples thereof include acrylic esters, acrylic amides, methacrylic esters, methacrylic amides, allyl compounds, vinyl ethers, vinyl esters, and the like. Among them, preferable are bi- or higher-functional acrylate compounds and methacrylate compounds.

(Pressure Sensitive Adhesive Layer)

An acrylic, rubber-based, or silicon-based pressure sensitive adhesive may be used as the pressure sensitive adhesive, but an acrylic pressure sensitive adhesive is preferable from the viewpoints of transparency and durability. Examples of the acrylic pressure sensitive adhesives include copolymers of 2-ethylhexyl acrylate, n-butyl acrylate, or the like (main component) with a short-chain alkyl acrylate or methacrylate such as methyl acrylate, ethyl acrylate, or methyl methacrylate, which is added for improvement in aggregation force, and an acrylic acid, methacrylic acid, an acryl amide derivative, maleic acid, hydroxylethyl acrylate, or glycidyl acrylate, which becomes the crosslinking point with a crosslinking agent. By properly adjusting the blending ratio and the kinds of the main component, the short-chain component, and the crosslinking-point component, it becomes possible to alter the glass transition temperature (Tg) and the crosslinking density of the pressure sensitive adhesive layer.

(Release Sheet)

Examples of the release sheets include papers and plastic films having a release agent layer of a stearate salt, silicone, soap, or the like formed on the surface.

The cover sheet for optical recording media described above is prepared by using a transparent sheet as the starting material and laminating other layers thereon, but may also be prepared by using a commercially available transparent sheet previously having a pressure sensitive adhesive layer, forming a hardcoat layer thereon, and cutting the resulting sheet as described above.

<Optical Recording Medium>

In a typical configuration, the optical recording medium according to the invention has a substrate and (an intermediate layer), (an reflective layer), (an intermediate layer), a recording layer, (an intermediate layer), an adhesive or pressure sensitive adhesive layer, a transparent sheet, and a hardcoat layer formed thereon in that order; and the transparent sheet and the hardcoat layer have the same configuration as that of the cover sheet for optical recording media according to the invention described above. In addition to the layers above, the optical recording medium may have another layer between respective layers for improvement in adhesiveness, recording characteristics, storability, or the like. In the configuration above, the layers in parenthesis are those that may be formed as needed.

Hereinafter, the substrate, other layers, and others for the optical recording medium according to the invention will be described respectively, taking the optical recording medium above as a typical example. However, the invention is not limited thereby.

(Substrate)

Specific examples of the substrate material include glass; polycarbonate; acrylic resins such as polymethyl methacrylate; vinyl chloride-based resins such as polyvinyl chloride and copolymers of vinyl chloride; epoxy resins; amorphous polyolefins; polyesters; and metals such as aluminum. If necessary, these materials may be used in combination.

Among the materials listed above, polycarbonate and amorphous polyolefins are preferable from the standpoints of moisture resistance, dimension stability, and cost. Polycarbonate is particularly preferable. The thickness of the substrate (the average thickness of the area where the recording layer is formed) is preferably in the range of 1.1±0.3 mm.

Guide grooves for tracking and concavities and convexities indicating such information as address signals (convex portions of the substrate are referred to as “on-grooves” and concave portions of the substrates are referred to as “in-grooves”; “on-grooves” may also be referred to as “grooves”) are formed on the substrate. In order to obtain a higher recording density, it is preferable to use a substrate whose grooves have a narrower track pitch relative to that of CD-R or DVD-R.

The track pitch of the grooves is preferably in the range of 300 to 360 nm, and more preferably 310 to 340 nm.

The depth of the grooves (groove depths) is preferably in the range of 20 to 50 nm. When the depth of the grooves is within this range, a propensity for tracking error signals to become smaller, thus bringing about difficulties in tracking, is contained, and a propensity for molding to become difficult can also be contained. The depth is more preferably 25 to 40 nm.

The half width of the on grooves is preferably confined within the range of 50 to 200 nm. When the half width of the on grooves is within this range, it becomes possible to reduce jitter, while at the same time containing the tendency for tracking error signals to become smaller. The half width of the grooves is more preferably confined within the range of 70 to 190 nm and still more preferably 90 to 180 nm.

Further, on the substrate surface of the side that is to have a reflective layer described later, an undercoat layer is preferably provided for such purposes as improvement of planarity and improvement of adhesion.

Examples of the material for the undercoat layer include polymeric substances such as polymethyl methacrylate, acrylic acid/methacrylic acid copolymers, styrene/maleic anhydride copolymers, polyvinyl alcohol, N-methylolacrylamide, styrene/vinyltoluene copolymers, chlorosulfonated polyethylene, nitrocellulose, polyvinyl chloride, chlorinated polyolefin, polyester, polyimide, vinyl acetate/vinyl chloride copolymers, ethylene/vinyl acetate copolymers, polyethylene, polypropylene, polycarbonate, and others; and surface-modifying agents such as silane coupling agents.

The undercoat layer can be formed by preparing a coating solution by dissolving or dispersing the above-mentioned material in a suitable solvent, and applying the coating solution to the substrate surface by a method such as spin coating, dip coating, extrusion coating, or the like. The thickness of the undercoat layer is normally in the range of 0.005 to 20 μm and preferably in the range of 0.01 to 10 μm.

Reflective Layer

A light-reflective substance having a high reflectance to a laser light is used in the reflective layer. The reflectance is preferably 70% or more.

Examples of the light-reflective substance having a high reflectance include metals and semimetals such as Mg, Se, Y, Ti, Zr, Hf, V, Nb, Ta, Cr, Mo, W, Mn, Re, Fe, Co, Ni, Ru, Rh, Pd, Ir, Pt, Cu, Ag, Au, Zn, Cd, Al, Ga, In, Si, Ge, Te, Pb, Po, Sn, and Bi, and stainless steel. These light-reflective substances may be used singly or in combinations of two or more, or alternatively as alloys. Among these substances, Cr, Ni, Pt, Cu, Ag, Au, Al, and stainless steel are preferable. Au, Ag, Al, and alloys thereof are more preferable. Ag, and alloys including Ag as the main component (Ag: 50 % by mass or more) are most preferable.

The reflective layer can be formed by, for example, vacuum-deposition, sputtering, or ion-plating of the above-mentioned light-reflective substance on the substrate. The layer thickness of the reflective layer is normally within the range of 10 to 300 nm and preferably within the range of 50 to 200 nm. The reflective layer is not always necessary if the reflectance of the recording layer that will be described later is sufficiently large.

(Recording Layer)

The recording layer is a layer capable of recording information with a laser light having a wavelength of 500 nm or less, which may be either in a dye-type layer containing an organic dye or a phase-change-type layer containing a phase-change-recording material.

Typical examples of the organic dyes include cyanine dyes, oxonol dyes, metal complex dyes, azo dyes, phthalocyanine dyes, and the like.

Preferable examples of the organic dye include the dyes described in JP-A Nos.4-74690, 8-127174, 11-53758, 11-334204, 11-334205, 11-334206, 11-334207, 2000-43423, 2000-108513, 2000-158818, etc.

Further, advantageously used are organic compounds such as a triazole compound, a triazine compound, a cyanine compound, a merocyanine compound, an aminobutadiene compound, a phthalocyanine derivative, a cinnamic acid compound, a viologen compound, an azo compound, an oxonolbenzoxazole compound, a benzotriazole compound, etc. Among these compounds, a cyanine compound, an aminobutadiene compound, a benzotriazole compound and a phthalocyanine compound are particularly preferable.

The recording layer is formed by preparing a coating solution by dissolving a recording substance such as an organic dye together with a binder, etc. in a suitable solvent, applying the coating solution to the reflective layer formed on the substrate surface to form a coated layer, and drying the coated layer. The concentration of the recording substance in the coating solution is normally in the range of 0.01 to 15% by mass, preferably in the range of 0.1 to 10% by mass, more preferably in the range of 0.5 to 5% by mass, and most preferably in the range of 0.5 to 3% by mass.

Examples of the solvents include esters such as butyl acetate, ethyl lactate, and cellosolve acetate; ketones such as methyl ethyl ketone, cyclohexanone, and methyl isobutyl ketone; chlorinated hydrocarbons such as dichloromethane, 1,2-dichloroethane, and chloroform; amides such as dimethylformamide; hydrocarbons such as methylcyclohexane; ethers such as tetrahydrofuran, ethyl ether, and dioxane; alcohols such as ethanol, n-propanol, isopropanol, n-butanol, and diacetone alcohol; fluorine-based solvents such as 2,2,3,3-tetrafluoropropanol; and glycol ethers such as ethylene glycol monomethyl ether, ethylene glycol monoethyl ether, and propylene glycol monomethyl ether.

These solvents may be used singly or in combinations of two or more by taking into consideration the solubility of the recording substance to be used. Further, according to purposes, the coating solution may contain additives such as an antioxidant, a UV absorber, a plasticizer, and a lubricating agent.

If a binder is used, examples of the binder include naturally occurring organic polymeric substances such as gelatin, cellulose derivatives, dextran, rosin, and rubber; hydrocarbon-based resins such as polyethylene, polypropylene, polystyrene, and polyisobutylene; vinyl-based resins such as polyvinyl chloride, polyvinylidene chloride, and vinyl chloride/vinyl acetate copolymers; acrylic resins such as polymethyl acrylate and polymethyl methacrylate; and synthetic organic polymers such as polyvinyl alcohol, chlorinated polyethylene, epoxy resins, butyral resins, rubber derivatives, and initial-stage condensation products of heat-curable resins such as phenol/formaldehyde resins. If the binder is used as a material for the recording layer, the amount of the binder to be used is normally in the range of 0.01 to 50 times (by mass ratio), preferably in the range of 0.1 to 5 times (by mass ratio), relative to the recording substance. The concentration of the recording substance in the coating solution thus prepared is normally in the range of 0.01 to 10% by mass and preferably in the range of 0.1 to 5 % by mass.

Examples of the method for applying the coating solution to the substrate include spraying, spin coating, dip coating, roll coating, blade coating, doctor roll coating, and screen printing. The recording layer may be composed of a single layer or of plural layers. The layer thickness of the recording layer is normally in the range of 20 to 500 nm, preferably in the range of 30 to 300 nm, and more preferably in the range of 50 to 100 nm.

The recording layer may contain various kinds of browning inhibitors for improving the light fastness of the recording layer.

Normally, a singlet oxygen quencher is used as the browning inhibitor. Singlet oxygen quenchers that are already described in publications such as patent specifications can be used as the browning inhibitors.

Specific examples of the quenchers include those described in JP-A Nos. 58-175693, 59-81194, 60-18387, 60-19586, 60-19587, 60-35054,60-36190, 60-36191, 60-44554, 60-44555, 60-44389, 60-44390, 60-54892, 60-47069, 63-209995, and 4-25492, Japanese Patent Application Publication (JP-B) Nos. 1-38680 and 6-26028, German Patent No.350399, Journal of the Chemical Society of Japan, No.10 (1992), p.1141, etc.

The amount of the browning inhibitor such as a singlet oxygen quencher to be used is normally in the range of 0.1 to 50% by mass, preferably in the range of 0.5 to 45% by mass, more preferably in the range of 3 to 40% by mass, and particularly preferably in the range of 5 to 25 % by mass, based on the amount of the organic dye.

Hereinafter, the phase-change-recording layer will be described. The phase-change-recording layer is a layer of a material that changes its phases repeatedly between crystalline and amorphous phases by irradiation with laser light.

An example of the layer is the one that changes its phase between crystalline and amorphous phases, for example, in the following manner: That is, part of a phase-change recording layer becomes melted by irradiation of focused laser pulses for a short period of time during information recording. The melted region is chilled rapidly by thermal diffusion, and solidifies, forming a recorded mark in the amorphous state. Alternatively, the recorded mark in the amorphous state becomes crystallized back to the original unrecorded state during information erasing, by the rise in the temperature of the recorded mark region to the crystallization temperature or more and the melting point of the recording layer or less by irradiation of laser beam and subsequent gradual cooling down.

Typical examples of the materials for the phase-change recording layer include alloys of Sb—Te, Ge—Sb—Te, Pd—Ge—Sb—Te, Nb—Ge—Sb—Te, Pd—Nb—Ge—Sb—Te, Pt—Ge—Sb—Te, Co—Ge—Sb—Te, In—Sb—Te, Ag—In—Sb—Te, Ag—V—In—Sb—Te, Ag—Ge—In—Sb—Te, and the like. Among them, Ge—Sb—Te and Ag—In—Sb—Te alloys are preferable, because the alloys allow repeated rewriting for a greater number of times.

The thickness of the phase-change recording layer is preferably 10 to 50 nm and more preferably 15 to 30 nm.

The phase-change recording layer above can be formed, for example, by a gas-phase thin film deposition method such as sputtering or vacuum deposition.

(Intermediate Layer)

The intermediate layer is a layer formed as needed between the recording layer and the pressure sensitive adhesive layer or the adhesive layer described below. The material for the intermediate layer is not particularly limited, if it transmits laser beam, but it is preferably dielectric; and specific examples thereof include inorganic oxides such as ZnS, TiO₂, SiO₂, ZnS—SiO₂, GeO₂, Si₃N₄, Ge₃N₄, MgF₂, ZnO—Ga₂O₃, and ZnO—Al₂O₃ and the nitrides, and sulfides thereof; and ZnS—SiO₂ are SiO₂ are preferable. The barrier layer can be formed, for example, by sputtering or ion plating, and the thickness is preferably 1 to 100 nm.

(Transparent Sheet and Hardcoat Layer)

The optical recording medium according to the invention should have a transparent sheet and a hardcoat layer, and the constituent materials and the properties of the transparent sheet and the hardcoat layer are the same as those described for the transparent sheet and the hardcoat layer of the cover sheet for optical recording media according to the invention. Accordingly, the optical recording medium according to the invention has a linear crack groove in the area close to the outer circumferential edge of the hardcoat layer and is resistant to separation in the edge area of the cover sheet.

In the optical recording medium according to the invention, the recording layer or the intermediate layer and the transparent sheet may be adhered to each other with a pressure sensitive adhesive layer or an adhesive layer. The pressure sensitive adhesive layer is already described in the description of the cover sheet for optical recording media according to the invention, and thus the adhesive layer will be described below.

(Adhesive Layer)

Similarly to the pressure sensitive adhesive layer above, the adhesive layer is a layer formed for adhesion of a transparent sheet. The materials for the adhesive layer include, for example, photocurable resins, twin-pack hardening adhesives, and the like; among them, a photocurable resin is preferable; and a resin having a smaller curing shrinkage rate is preferable for prevention of bend of the disk. Examples of the photocurable resins include UV-curable resins (UV-curable adhesives) such as “SD-640”, “SD-661”, and “SD-347” manufactured by Dainippon Ink and Chemicals, Inc., and the like. The thickness of the adhesive layer is preferably in the range of 1 to 50 μm, more preferably, 5 to 45 μm, and particularly more preferably 10 to 40 μm, for providing the layer with a sufficient elasticity.

Examples of other material constituting the adhesive layer are listed below. The material may be a radiation-curable resin, the molecule of which comprises at least two radiation-functional double bonds. Specific examples of the resin include acrylic esters, acrylamides, methacrylic esters, methacrylamides, allyl compounds, vinyl ethers, vinyl esters, etc. Acrylates and methacrylates, which are each at least bifunctional, are preferred compounds.

Specific examples of the bifunctional compounds that can be used are those prepared by the addition of acrylic acid or methacrylic acid to aliphatic diols and represented by ethylene glycol diacrylate, propylene glycol diacrylate, butanediol diacrylate, hexanediol diacrylate, diethylene glycol diacrylate, triethylene glycol diacrylate, tetraethylene glycol diacrylate, neopentyl glycol diacrylate, tripropylene glycol diacrylate, ethylene glycol dimethacrylate, propylene glycol dimethacrylate, butanediol dimethacrylate, hexanediol dimetbacrylate, diethylene glycol dimethacrylate, triethylene glycol dimethacrylate, tetraethylene glycol dimethacrylate, neopentyl glycol dimethacrylate, tripropylene glycol dimethacrylate, etc.

Further examples of the compounds that can be used are polyether acrylates and polyether methacrylates prepared by the addition of acrylic acid or methacrylic acid to a polyetherpolyol such as polyethylene glycol, polypropylene glycol, polytetramethylene glycol, or the like; and polyester acrylates and polyester methacrylates prepared by the addition of acrylic acid or methacrylic acid to a polyesterpolyol obtained from a known dibasic acid and a glycol.

Further examples of the compounds that can be used are polyurethane acrylates and polyurethane methacrylates prepared by the addition of acrylic acid or methacrylic acid to a polyurethane obtained from a reaction between a known polyol or diol and a polyisocyanate.

Still further examples of the compounds that can be used are the reaction products prepared by the addition of acrylic acid or methacrylic acid to bisphenol A, bisphenol F, hydrogenated bisphenol A, hydrogenated bisphenol F, or an alkylene oxide adduct thereof; and compounds having a cyclic structure such as an isocyanuric acid alkylene oxide-modified diacrylate, an isocyanuric acid alkylene oxide-modified dimethacrylate, tricyclodecanedimethanol diacrylate, tricyclodecanedimethanol dimethacrylate, etc.

An electron beam and ultraviolet light can be used as the above-mentioned radiation. When ultraviolet light is used, it is necessary to add a photopolymerization initiator to the following compounds. An aromatic ketone is used as the photopolymerization initiator. Although the kind of the aromatic ketone is not particularly limited, a preferred aromatic ketone is one having an absorption coefficient is relatively large at the wavelengths of 254 nm, 313 nm, and 865 nm where bright line spectra are generated by a mercury lamp normally used as a light source of ultraviolet radiation. Typical examples of the aromatic ketone include acetophenone, benzophenone, benzoin ethyl ether, benzyl methyl ketal, benzyl ethyl ketal, benzoin isobutyl ketone, hydroxydimethyl phenyl ketone, 1-hydroxycyclohexyl phenyl ketone, 2-2-diethoxy acetophenone, Michler's ketone, etc. Various aromatic ketones can be used. Since ultraviolet light-curable adhesives, which already contains a photopolymerization initiator, are commercially available, such a ultraviolet light-curable adhesive may be used. A mercury lamp is used as the ultraviolet light source. As to the mercury lamp, a mercury lamp of 20 to 200 W/cm is used at a speed of 0.3 to 20 n/min. Normally the distance between the substrate and the mercury lamp is preferably 1 to 30 cm.

As to the electron beam accelerator, although a scanning system, a double scanning system, or a curtain beam system can be employed, a curtain beam system is preferable because a large output power is obtained at a relatively inexpensive cost. As to the electron beam characteristics, the acceleration voltage is 100 to 1000 kV and preferably 150 to 300 kV, and the absorbed dose is 0.5 to 20 Mrad and preferably 1 to 10 Mrad. Energy transmission is insufficient if the acceleration voltage is less than 100 kV, whereas energy efficiency is reduced and thus the cost is disadvantageous if the acceleration voltage exceeds 1000 kV.

For prevention of the bend of disk, it is preferable to use a pulse-model photoirradiator (preferably, UV irradiator) for ultraviolet irradiation of the coated film. The pulse interval is preferably 1 msec or less and more preferably 1 μsec or less. The irradiation intensity per pulse is not particularly limited, but, preferably 3 kW/cm² or less and more preferably, 2 kW/cm² or less.

The frequency of irradiation is also not particularly limited, but preferably twenty times or less and more preferably ten times or less.

The methods of recording and reproducing information on the optical recording medium according to the invention will be described below.

Information is recorded on an optical recording medium in, for example, the following manner: A laser beam for recording having a wavelength of 350 to 500 nm (preferably, 400 to 440 nm) is first irradiated from the transparent sheet side (opposite side to the substrate side) while rotating the optical recording medium at a constant linear velocity. By irradiation of the laser beam, the recording layer absorbs the light, resulting in local temperature rise and change in physical or chemical properties (e.g., generation of pits), which in turn leads to changes in optical properties. Information is recorded by the changes in optical properties.

Examples of the laser beam sources emitting a laser having an oscillation wavelength of 350 to 500 nm include blue purple semiconductor lasers having an oscillation wavelength in the range of 390 to 415 nm, blue purple SHG lasers having a central oscillation wavelength of approximately 430 nm, and the like.

For improvement in recording density, the numerical aperture (NA) of the object lens used as a pickup is preferably 0.7 or more and more preferably 0.80 or more.

On the other hand, reproduction of the recorded information is performed by irradiating a laser beam having a wavelength identical with or shorter than that of the laser used for information recording from the transparent sheet side and detecting the reflected beam while rotating the optical recording medium at the same constant linear velocity as that above.

### EXAMPLE

Hereinafter, the present invention will be described in detail with reference to Examples, but it should be understood that the invention is not restricted by these examples.

### Examples 1 to 4 and Comparative Examples 1 and 2

(1) Preparation of Hardcoat Layer-Coating Solution

<Preparation of Hardcoat Layer-Coating Solution (HC1)>

A thermal polymerization initiator V-65 (manufactured by Wako Pure Chemical Industries) was added dropwise to a solution of glycidyl methacrylate in methylethylketone (MEK) at 80° C. over a period of 2 hours and the mixture was allowed to react therein; the reaction solution obtained was added dropwise to hexane, and the resulting precipitate was collected and dried under reduced pressure, to give polyglycidyl methacrylate (molecular weight as polystyrene: 12,000); the polyglycidyl methacrylate was dispersed in methylethylketone at a concentration of 50 mass %; and a solution of 150 parts by mass of trimethylolpropane triacrylate (BISCOAT #295, manufactured by Osaka Organic Chemical Industry Ltd.), 6 parts by mass of a photocationic polymerization initiator (Rhodesil 2074, manufactured by Rhodia), and 10 parts by mass of a solution of MEGAFACE 531 A (manufactured by Dainippon Ink and Chemicals, Inc.) in 30 parts by mass of methylisobutylketone was added to 100 parts by mass of the solution above while the mixture was stirred, to give a hardcoat layer-coating solution (HC1).

<Preparation of Hardcoat Layer-Coating Solution (HC2)>

93 parts by mass of dipentaerythritol hexaacrylate (DPHA, manufactured by Daicel-UCB Company Ltd.), 5 parts by mass of R-3833 (manufactured by Daikin Fine Chemical Laboratory), 2 parts by mass of X-22-164C (manufactured by Shin-Etsu Chemical Co., Ltd.), and 3 parts by mass of a photo-radical polymerization initiator (IRGACURE 907, manufactured by Ciba Specialty Chemicals) were mixed and dissolved in a liquid mixture of methylethylketone and methylisobutylketone (1:1 mass ratio), to give a hardcoat layer-coating solution (HC2).

(2) Preparation of Pressure Sensitive Adhesive-Coating Solution A

Solutions of acrylic copolymers (solvent: ethyl acetate/toluene=1/1, the same shall apply hereinafter) and of an isocyanate crosslinking agent (solvent: ethyl acetate/toluene-1/1, the same shall apply hereinafter) were mixed at an acrylic copolymer/isocyanate crosslinking agent ratio of 100:1 (mass ratio), to give a pressure sensitive adhesive-coating solution A. The composition of the acrylic copolymers used was as follows:

Main monomers: n-Butyl acrylate 40 parts by mass
2-Ethylhexyl acrylate 30 parts by mass

Comonomer: Methyl acrylate 25 parts by mass

Functional monomer: Acrylic acid 5 parts by mass

(3) Coating, Drying, and Winding

In each Example and Comparative Example, the hardcoat layer-coating solution HC1 or HC2 obtained was coated on a rolled transparent sheet (polycarbonate: PUREACE, manufactured by Teijin Ltd., thickness 80 μm) as shown in Table 1, forming a coated layer, which was dried under heat and hardened by continuous irradiation of ultraviolet light, to give a hardcoat layer. The transparent sheet carrying the coated layer of 5 μm in thickness was wound around a roll.

Separately, the pressure sensitive adhesive-coating solution A was coated continuously on a polyethylene release sheet to the dry-film thickness shown in Table 1, while feeding the release sheet from its roll. Immediately after drying in a drying zone (100° C.), the pressure sensitive adhesive face of the release sheet was adhered onto the face of the cover sheet opposite to the hardcoat layer formed, and the resulting sheet was wound around a roll. The sheet wound together was then kept under the condition of 23° C. and 50% RH for 72 hours.

(4) Punching

The cover film carrying the release sheet adhered was punched into the same shape as that of the optical recording medium substrate to be prepared, to give a transparent sheet of optical recording medium. However at the time, each release sheet of Example or Comparative Examples was left at the semi-cut state in the form identical with the disk substrate, by cutting the sheet with a cutter having the blade edge angle shown in Table 1, and wound into a roll.

(5) Preparation of Optical Recording Medium

A reflective layer having a thickness of 100 nm was formed by sputtering Ag on the groove face of an substrate of 1.1 mm in thickness and 120 mm in diameter having spiral grooves (100 nm, width: 120 nm, track pitch: 320 nm) of an injection-molding polycarbonate resin (PANLITE AD5503, polycarbonate manufactured by Teijin Chemicals Ltd.).

Then, a phthalocyanine dye (ORAZOLE Blue GN, manufactured by Ciba Specialty Chemicals) was added to 2,2,3,3-tetrafluoropropanol and dissolved therein by ultrasonication for 2 hours, to give a dye-coating solution. The dye-coating solution was coated on the reflective layer by spin coating under the condition of 23° C. and 50% RH while changing the spinning frequency from 300 rpm to 4,000 rpm, forming a recording layer (thickness: 80 nm).

After storage at 23° C. and 50% RH for 1 hour, ZnS and SiO₂ were deposited on the recording layer by sputtering, to give an intermediate layer having a thickness of 5 nm.

After the intermediate layer is formed, the release sheet on the transparent sheet described above having a hardcoat layer and a pressure sensitive adhesive layer was peeled off, and the transparent sheet was adhered onto the intermediate layer by using a roll as pressure means, to give an optical recording medium.

### Example 5 and Comparative Example 3

The pressure sensitive adhesive-coating solution A prepared in the “(2) preparation of adhesive-coating solution A” of Examples 1 to 4 and Comparative Examples 1 and 2 was replaced with the following UV-curable adhesive. That is, a suitable amount of the UV-curable adhesive was dropped on a substrate having a recording layer; a cover sheet having a hardcoat layer was laid thereon; and an adhesive layer having a desirable thickness was formed by spin coating and hardened by UV irradiation. The UV-curable resin (adhesive) used was SD661 manufactured by Dainippon Ink and Chemicals, Inc. Optical recording media of Example 5 and Comparative Example 3 were prepared in a similar manner to Examples 1 to 4 and Comparative Examples 1 and 2, except above.

### Example 6 and Comparative Example 4

Optical recording media of Example 6 and Comparative Example 4 were prepared in a similar manner to Examples I to 4, Comparative Examples 1 and 2, except that the transparent sheet used in “(3) coating, drying, and winding” was replaced with a cellulose triacetate sheet (FUJITAC, manufacture by Fuji Photo Film Co., Ltd.) and a cutter having the blade edge angle shown in Table 1 was used in “(4) punching” of Examples 1 to 4 and Comparative Examples 1 and 2.

Evaluation

Each of the optical recording media prepared in Examples 1 to 6 and Comparative Examples 1 to 4 was stored in an environment of 80° C. and 85% RH for 240 hours; an adhesive tape was attached to the outer circumferential area of the hardcoat layer of each optical recording medium; and separation of the edge area when the adhesive tape was pulled in the 180°-opposite direction at a load of 10 g was observed. Results are summarized in Table 1.

TABLE

| | | | | Thickness of | Blade | Crack groove in area | |
|---|---|---|---|---|---|---|---|
| | Transparent | Hardcoat | | pressure sensitive | edge | close to outer | Edge separation |
| | sheet | layer | Adhesive | adhesive layer | angle | circumferential edge | after storage |
| Example 1 | Polycarbonate | HC1 | Pressure sensitive adhesive | 15 | 40° | Yes | No |
| Example 2 | Polycarbonate | HC2 | Pressure sensitive adhesive | 15 | 40° | Yes | No |
| Example 3 | Polycarbonate | HC2 | Pressure sensitive adhesive | 10 | 40° | Yes | No |
| Example 4 | Polycarbonate | HC2 | Pressure sensitive adhesive | 15 | 20° | Yes | No |
| Example 5 | Polycarbonate | HC2 | UV-curable adhesive | — | 40° | Yes | No |
| Example 6 | TAC | HC2 | Pressure sensitive adhesive | 15 | 40° | Yes | No |
| Comparative | Polycarbonate | HC1 | Pressure sensitive adhesive | 15 | 15° | No | Yes |
| Example 1 | | | | | | | |
| Comparative | Polycarbonate | HC2 | Pressure sensitive adhesive | 15 | 15° | No | Yes |
| Example 2 | | | | | | | |
| Comparative | Polycarbonate | HC2 | UV-curable adhesive | — | 15° | No | Yes |
| Example 3 | | | | | | | |
| Comparative | TAC | HC2 | Pressure sensitive adhesive | 15 | 15° | No | Yes |
| Example 4 | | | | | | | |

As apparent from Table 1, the optical recording media of Examples 1 to 6 having a linear crack groove in the area close to the outer circumferential edge of the hardcoat layer exhibited no separation of the edge area, while the optical recording media of Comparative Examples 1 to 4 having no linear crack groove exhibited separation in the edge area. Thus, the presence of a linear crack groove in the area close to the outer circumferential edge of the hardcoat layer allows production of optical recording media resistant to separation in the edge area.

The invention provides a cover sheet for optical recording media that are resistant to separation of the edge area when the cover sheet is used as a cover sheet for optical recording media. The invention also provides an optical recording medium resistant to separation of the edge area of the cover sheet.

What is claimed is:

1. A cover sheet for optical recording media, comprising a transparent disk-shaped sheet having a central hole and a hardcoat layer formed thereon, wherein the hardcoat layer has a linear crack groove in a circumferential direction in an area close to an outer circumferential edge thereof.

2. The cover sheet for optical recording media according to claim 1, wherein the linear crack groove is present around the entire circumference in the area of the hardcoat layer close to the outer circumferential edge.

3. The cover sheet for optical recording media according to claim 1, wherein the cover sheet is a lamninated film having a release sheet adhered via a pressure sensitive adhesive layer onto the face of the transparent sheet opposite to the hardcoat layer.

4. The cover sheet for optical recording media according to claim 3, wherein the pressure sensitive adhesive layer contains an acrylic pressure sensitive adhesive.

5. The cover sheet for optical recording media according to claim 1, wherein the hardcoat layer has a surface elastic modulus of 4 GPa or more.

6. The cover sheet for optical recording media according to claim 1, wherein the transparent sheet contains polycarbonate or cellulose triacetate.

7. The cover sheet for optical recording media according to claim 1, wherein the transparent sheet has a thickness of 0.03 to 0.15 mm.

8. The cover sheet for optical recording media according to claim 1, wherein the hardcoat layer contains a bi- or higher-functional acrylate or methacrylate compound.

9. An optical recording medium, comprising a disk-shaped substrate having a central hole and at least a recording layer, a transparent sheet, and a hardcoat layer formed in that order thereon, wherein the hardcoat layer has a linear crack groove in a circumferential direction in an area close to an outer circumferential edge thereof.

10. The cover sheet for optical recording media according to claim 9, wherein the linear crack groove is present around the entire circumference in the area of the hardcoat layer close to the outer circumferential edge.

11. The cover sheet for optical recording media according to claim 9, wherein the hardcoat layer has a surface elastic modulus of 4 GPa or more.

12. The cover sheet for optical recording media according to claim 9, wherein the transparent sheet contains polycarbonate or cellulose triacetate.

13. The cover sheet for optical recording media according to claim 9, wherein the transparent sheet has a thickness of 0.03 to 0.15 mm.

14. The cover sheet for optical recording media according to claim 9, wherein the hardcoat layer contains a bi- or higher-functional acrylate or methacrylate compound.
